(19) United States
(12) Patent Application Publication
(10) Pub. No.: US 2008/0154999 A1
(43) Pub. Date: Jun. 26, 2008

(54) Compressed Floating Point Representation Of Points On Monotonic Curves Which Can Be Specified By High Order Equations

(75) Inventors: Puneet Sardana, Bangalore (IN); Neeraj Tyagi, Bangalore (IN); Sureshkumar Manimuthu, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/613,205

(22) Filed: Dec. 20, 2006

(51) Int. Cl. G06F 1/02; G06F 7/556; G06F 7/50

(52) U.S. Cl. 708/277; 708/495; 708/270; 708/505

(57) ABSTRACT

Using different number of data bits to represent points in corresponding different sections of a high order monotonic curve in a floating point format. More number of data bits are used to represent one section of the curve, while correspondingly fewer data bits are used to represent another section of the curve. In one embodiment, the differences of mantissa values of successive points are stored in a memory to obtain compression, but with different number of bits for different sections of the curve. The absolute values of the exponents for each section are also stored. The high order monotonic curve may represent a de-gamma curve and used in processing video signals which are to be de-gamma corrected.

### BACKGROUND

1. Field

The present disclosure relates generally to digital systems operating with data representing curves, and more specifically to compressed floating point representation of monotonic curves which can be specified by high order equations, and also to its application to video display systems.

2. Related Art

The relation between two related variable quantities (for example, an input variable and a corresponding output variable) may be specified in the form of an equation. Such an equation can be of a high order (greater than one). For example, an equation specifying the relation between an input variable x and an output variable y may take the form y=x̂a, where the symbol ̂represents a “raised to the power of” operation. The numerical value of “a” in the above equation is often termed the order of the equation. When “a” takes on values higher than 1 the equation may be termed as a high order equation.

Curves can generally be specified by such high order equations, with the order determined by the shape of the curve and the desired accuracy. Further, such curves may be monotonic, i.e., as the x component increases, the corresponding y component also increases. A curve represented by the equation y=x̂a noted above is an example of a monotonic curve specified by a high order equation.

As an example, the intensity level of video signals is often gamma-corrected to account for the fact that the conventional cathode ray tube (CRT) response is not linear as related to brightness level on the display screen versus the received signal values (voltages). The Gamma curve also represents a monotonic curve.

At least to save processing resources and/or time, data indicating various points (of interest) on the curves are often generated and stored. Continuing with the example above, it may be desirable to store in a video processing equipment points representing de-gamma curves, assuming the corresponding display has a linear response and it is thus needed to reverse the gamma correction, i.e., perform de-gamma correction. Thus, points representing de-gamma curve may need to be stored. Points representing other curves can be stored for other purposes as well.

The points on a curve are often represented using floating point notation, for reasons such as higher accuracy, ability to represent a wider range of values, etc. Each floating point value in turn is generally represented using a mantissa value and an exponent value (with a radix/base value often assumed, implicit or fixed).

When such floating point representations of curves are used in a digital system, it is often desirable to store such representation in a compressed form, at least for reducing the storage space requirements. For example, the points on the de-gamma curves noted above, may need to be stored in a compressed floating point form to reduce storage space requirement.

It is often required that the storage requirements be further reduced by appropriate representation in compressed format.

### BRIEF DESCRIPTION OF THE DRAWINGS

The present invention will be described with reference to the following accompanying drawings, which are described briefly below.

FIG. 1 is a block diagram illustrating an example environment in which various aspects of the present invention can be implemented.

FIG. 2A is a diagram illustrating a de-gamma curve in one embodiment.

FIG. 2B is a diagram showing points of interest on a de-gamma curve.

FIG. 3 is a graph depicting the exponent and mantissa values for various output points corresponding to the input values of a de-gamma curve.

FIG. 4 is a block diagram illustrating the manner in which de-gamma values are stored in a compressed form in an embodiment of the present invention.

FIG. 5 is a block diagram illustrating the details of a video data processing block in an embodiment of the present invention.

FIG. 6 is a flowchart illustrating the manner in which a de-gamma curve may be reconstructed from the compressed values in an embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

According to an aspect of the present invention, different numbers of data bits are used to represent (in a random access memory, registers, non-volatile memory, transmission signal, etc.) a high order monotonic curve in corresponding different sections of the curve in a floating point format. More data bits are used to represent one section of the curve (for example, closer to the origin of the curve), while correspondingly fewer data bits are used to represent another section (for example, farther from the origin) of the curve.

In an embodiment, each point on the curve is represented by a mantissa value and an exponent value. The differences of mantissa values of successive points are stored in a memory to obtain compression, but with different number of bits for different sections of the curve. The absolute values of the exponents for each section may also be stored. An index value specifying the memory location at which the number of bits used for storing the differences in the mantissa changes, is also stored.

In an embodiment containing a digital light processing system (DLP) employing digital micromirror devices (DMD) for display, de-gamma curves used to reverse the gamma correction applied to video signals are stored in compressed floating point format as described above.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. EXAMPLE ENVIRONMENT

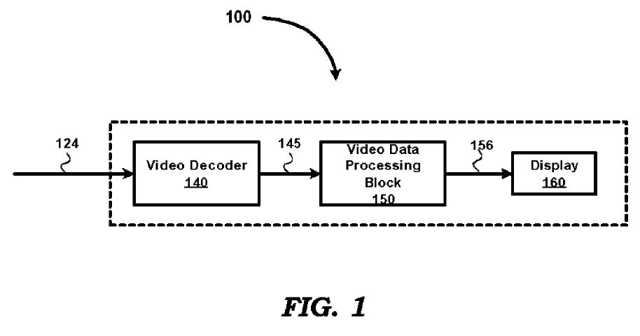

FIG. 1 is a block diagram of an example environment in which various aspects of the present disclosure can be implemented. The block diagram is shown containing video system 100 containing video decoder 140, video data processing block 150 and display 160. The video system may correspond to a television system or other display devices, which reproduce the content represented by a video signal. Each block is described below in further detail.

Display 160 provides visual display of video data/signals received from video data processing block 150 on path 156. The video data may represent the image frames to be displayed and the signals indicate various control signals such as horizontal/vertical synchronization signals. In an embodiment, display 160 corresponds to a DMD display.

Video decoder 140 receives a composite video signal on path 124 (which may be a wireline or a wireless path). Video decoder 140 may demodulate the video signal, convert the composite analog video signal to digital video data, and forward the digital video data (along with indication of HSYNC/VSYNC information) to video data processing block 150 on path 145.

Video data processing block 150 generates video data/signals consistent with the interface requirements of display 160 to render images on display 160. Generating such signals may entail various processing tasks such as color space conversion, image formatting and image enhancement, such that the display signals are suited to the response of display 160.

In addition, the combination of a portion of video data processing block 150 in conjunction with display 160 may have a linear response with respect to signal values (defining characteristics such as desired brightness, contrast, hue, etc.) provided versus the corresponding characteristics that would be perceived by the human eye. Accordingly, data representing de-gamma curves may be used for de-gamma correction, and several aspects of the present invention enable such de-gamma data to be represented (and stored) in a compact form as described in further detail below. First, the de-gamma curve (representing a high order monotonic curve) in an embodiment is illustrated below.

### 3. DE-GAMMA CURVE

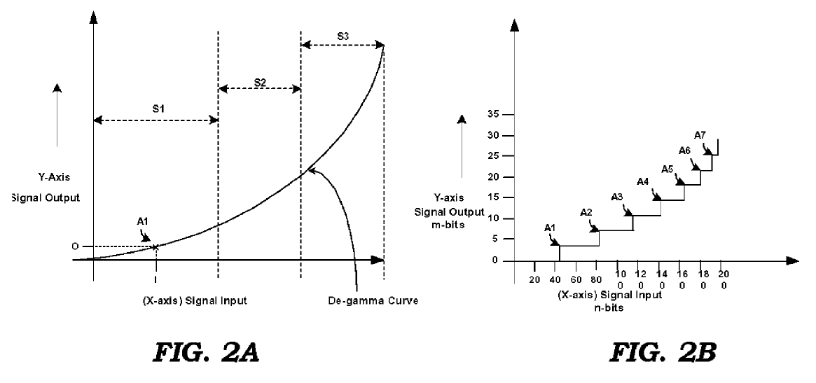

FIG. 2A is a diagram showing an example de-gamma curve. The diagram shows the de-gamma curve plotted as a function of signal input (signal values specifying intensity of points on the display along the x-axis) versus a signal output (shown along the y-axis) corresponding to the desired output light intensity (which would be used for generating video data to display 160). It may be observed that the de-gamma curve is monotonic.

De-gamma correction may be applied by mapping a signal input value (example 1) to the corresponding de-gamma(ed) output (O) value representing the desired output light intensity using the de-gamma curve of FIG. 2A.

Video data processing block 150 (FIG. 1) may store digital values (magnitudes on Y-axis on FIG. 2A) of points of interest on the de-gamma curve of FIG. 2A. As shown in FIG. 2B, a set of de-gamma values (generally determined a priori) specified by points A1 through A7 may be stored.

In FIG. 2B, the x-axis (signal input) represents the intensity of video signal provided to video data processing block 150 on path 145 and may be n-bits wide, while the corresponding video signal (“signal output” as shown on the y-axis of FIG. 2B) may be m-bits wide, with “m” and “n” represent integers.

Video data processing block 150 may use floating point format for representing data values on Y-axis of FIG. 2B. Consequently, magnitudes of each of de-gamma values A1 through A7 may be represented in a floating point format in video data processing block 150, with each point A1 through A7 having a mantissa value and an exponent value.

The de-gamma values are represented in compressed format according to an aspect of the present invention based on the observations briefly described below.

### 4. OBSERVATIONS

In FIG. 2A, three representative sections of the de-gamma curve are shown marked as S1, S2 and S3. In a lower section (S1, closer to the origin) of the de-gamma curve the exponent values of the points are generally smaller, while in successive higher sections S2 and S3 the exponent values of corresponding points are larger. Therefore, differences of the mantissa values of successive points in section S1 may have a wider range of values, and may require a larger number of bits to store those values.

The differences of the mantissa values of successive points in sections S2 and S3 may have progressively smaller ranges and thus may need correspondingly a fewer number of bits. This is further illustrated in the next section wherein points of interest located on the de-gamma curve of FIG. 2A are shown plotted in mantissa-exponent form.

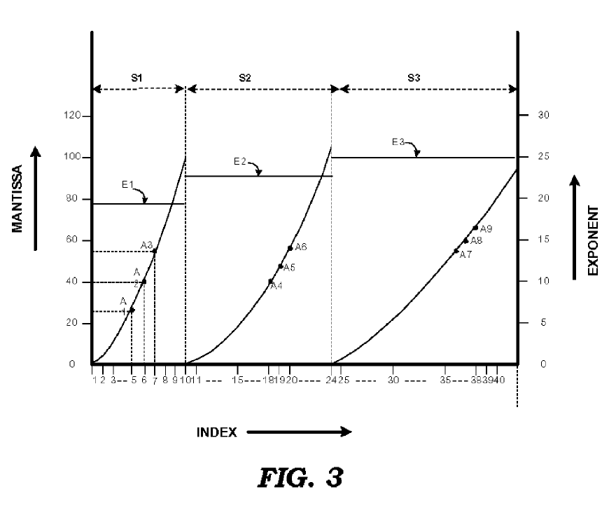

FIG. 3 is a graph depicting the exponent and mantissa values for various output points corresponding to the input values of the de-gamma curve of FIG. 2A. The index is shown on the horizontal axis and the mantissa and exponent values are shown on the two vertical axis. The de-gamma curve is shown with three sections S1, S2, and S3, which (i.e., all points on the section) respectively are represented having exponent values of E1, E2 and E3. On the other hand, the mantissa value changes for each point of the respective section and maps to the value on Mantissa axis.

The index may represent the input signal value (X-axis on FIG. 2B) and the corresponding point represents the output value according to the applicable exponent and mantissa values. Thus, points A1, A2 and A3 corresponding to index values 5, 6 and 7 are shown located on section S1, and all have an exponent value equal to E1 (value 19). Points A4, A5 and A6 corresponding to index values 18, 19 and 20 are shown located on section S2, and all have an exponent value equal to E2 (value 23). Points A7, A8 and A9 corresponding to index values 38, 39 and 40 are shown located on section S3, and all have an exponent value equal to E3 (value 25).

In section S1, with points having a smaller exponent value (E1=19), there may be a large variation in the corresponding mantissa values. For example, (first) differences in the mantissa values of successive points A1 and A2 is 13 (40-27), and for successive points A2 and A3 is A3−A2=15(55−40).

In section S2, with points having a larger exponent value (E2=23), there may be a relatively smaller variation in the corresponding mantissa values. For example, (first) differences in the mantissa values of successive points A4 and A5 is 8 (48−40), and for points A5 and A6 is 8 (56−48).

In section S3, with points having an even larger exponent value (E3=25), there may be an even smaller variation in the corresponding mantissa values. For example, (first) differences in the mantissa values for points A7 and A8 is 5 (60−55), and for points A8 and A9 is 5 (65−60).

The index, mantissa and exponent values as shown in FIG. 3 illustrate the general nature of the observation, and may not precisely correspond to values on a typical de-gamma curve. It may be noted that in a typical de-gamma curve, the variations in differences of mantissa values among different sections of the curve may typically be even wider.

Further, even though each section of the curve is shown with a corresponding value of the exponent, it should be appreciated that the same section (which uses the same number of bits for representation of the mantissa differences) can have multiple exponent values. Also, it must be understood that while sections S1, S2 and S3 are shown as being continuous for the sake of clarity, each of the sections contains discrete points of interest (akin to FIG. 2B).

It may be observed from the description above that when the exponent value of points on the de-gamma curve is smaller, corresponding differences of mantissa values are larger, and generally more bits are needed to store the differences.

Thus, according to an aspect of the present invention, more number of data bits are used to store differences in mantissa values in one section of the curve (for example, section S1 closer to the origin), while correspondingly fewer data bits are used to store differences in mantissa values in other sections of the curve (for example, sections S2 and S3). An embodiment of the present invention is accordingly described below.

### 5. COMPRESSED REPRESENTATION OF A DE-GAMMA CURVE

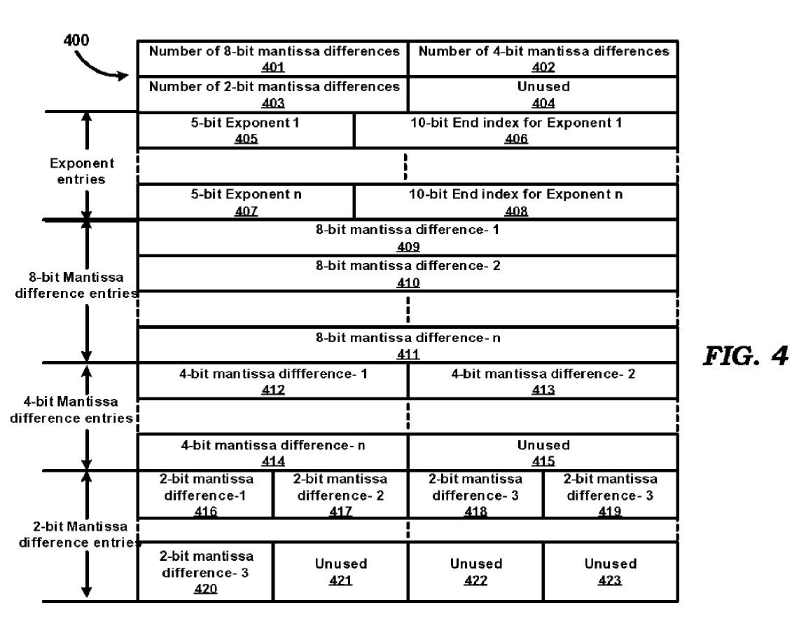

FIG. 4 is a block diagram illustrating the manner in which de-gamma values are stored in a compressed form in an embodiment of the present invention. For illustration, a signed floating point format with 1 bit for the sign, 5 bits for the exponent and 7 bits for the mantissa is used in the example. The diagram shows table 400 stored in a non-volatile memory (e.g., flash or ROM-read only memory) containing entries in fields 401 through 423 (some fields are not used, as noted below). In the interest of clarity, the entries in table 400 will be described with reference to the (various sections of) de-gamma curve shown in FIG. 3.

Again, merely as an example, in the embodiment of FIG. 4, three different bit-widths (sizes) are used for storing mantissa differences. 8-bit widths are used for storing mantissa differences corresponding to a lower section (closer to the origin) of the de-gamma curve (for example, corresponding to section S1), 4-bit widths are used for storing mantissa differences corresponding to an intermediate section of the de-gamma curve (for example, corresponding to section S2), and 2-bit widths are used for storing mantissa differences corresponding to a higher section (further away from the origin) of the de-gamma curve (for example, corresponding to section S3). Each field in table 400 is described in detail below.

Fields 401, 402 and 403 store the number of exponents for which the corresponding mantissa differences are stored using 8 bits, 4 bits and 2 bits respectively. With reference to FIG. 3, fields 401, 402 and 403 each contains a value 1, as in the de-gamma curve of FIG. 3, each section uses a single exponent value. However, if a section spans curve portions with different exponent values, the number of portions with the corresponding exponent value may be stored in the fields. Fields 401, 402 and 403 may each be 8-bits wide.

Field 405 stores the 5-bit exponent of the first (lowermost-closest to the origin) portion of the curve. With reference to FIG. 3, the entry contains a value 19 (the value of E1), being the value of exponent E1 corresponding to the only portion contained in section S1. Field 406 stores the 10-bit index of the last de-gamma value which uses the same exponent value as stored in field 405. From FIG. 3, Field 406 contains an entry 10 (assuming 10 points are there in portion S1, though only points with input values (index) of 1, 5, 6, and 7 are shown in FIG. 3). Fields 405-408 are denoted as “exponent entries” in FIG. 4.

Fields 407 and 408 are similar to fields 405 and 406, except that fields 407 and 408 store the exponent and index corresponding to the last section (farthest from the origin) of the de-gamma curve (the only portion in section S3 in FIG. 3). Entries for intermediate sections (with corresponding values of the exponent, for example section S2) may be entered in fields not shown, but deemed to be present (denoted by dotted lines between fields 405/406 and 407/408). Field 407 may also be using 5-bit exponent value, though a different number of bits can be used.

Field 409 stores the first 8-bit mantissa difference (difference between mantissa values of de-gamma data (not shown) with indices 1 and 2 in FIG. 3). The first value may be represented as a difference of the first point from a pre-specified value (e.g., 0 or mid-value).

Field 410 stores the second 8-bit mantissa difference (difference between mantissa values of de-gamma data with indices 2 and 3 in FIG. 3). Similarly, Field 411 stores the last 8-bit mantissa difference (difference between mantissa values of de-gamma data with indices 8 and 9 in FIG. 3). Entries for other 8-bit mantissa differences may be entered in fields not shown, but deemed to present (denoted by dotted lines between fields 410 and 411). Fields 409-411 are 8-bits wide and are denoted as “8-bit mantissa difference” entries in FIG. 4.

Fields 412 through 414 similarly store entries for 4-bit mantissa differences, while fields 416 through 420 store entries for 2-bit mantissa differences. Fields 412-415 are 4-bits wide each and are denoted as “4-bit mantissa difference” entries in FIG. 4. Fields 416-423 are 2-bits wide each and are denoted as “2-bit mantissa difference entries” in FIG. 4. Fields 404, 415, 421, 422 and 423 are not used.

It should be noted that at index points where the exponent value changes (indices 10 and 24 in FIG. 3), a mantissa difference yields a negative number (such as the difference of mantissas for de-gamma data with indices 11 and 10 in FIG. 3). In such a case, a value of 128 (128 being the largest difference possible between two 7-bit mantissa values) is added to the difference to ensure that all mantissa differences are positive. Thus, for example, a value of 128 would be added to the mantissa value with index 11 (FIG. 3), and the difference between mantissa values with index 11 and index 10 would then be stored as the mantissa difference.

Thus, using different bit-widths for mantissa differences in different sections, de-gamma data may be stored efficiently in a compressed form resulting in storage space savings. The data in such compressed format may be stored within video data processing block 150, as described below.

### 6. VIDEO DATA PROCESSING BLOCK

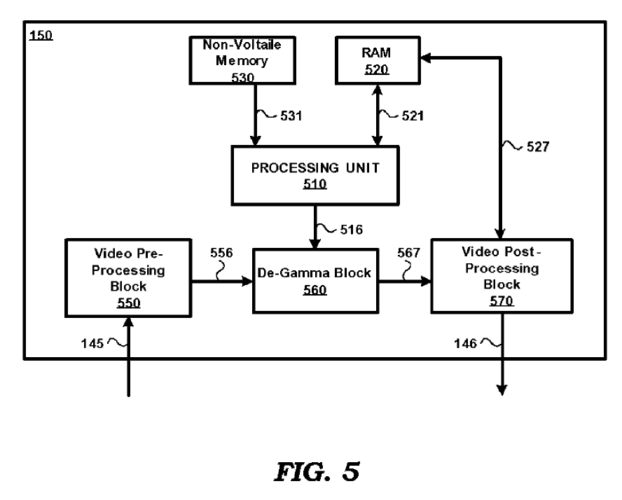

FIG. 5 is a block diagram illustrating the details of video data processing block 150 in one embodiment. Video data processing block 150 is shown containing processing unit 510, random access memory (RAM) 520, non-volatile memory 530, video pre-processing block 550, de-gamma block 560 and video post-processing block 570. Each component is described in further detail below.

RAM 520 and non-volatile memory 530 may together or individually be referred to as a memory. In particular, non-volatile memory 530 may store de-gamma values in a compressed form, for example, in a de-gamma table such as table 400 of FIG. 4. Non-volatile memory 530 may also store the software instructions and data, which enable video data processing block 150 to provide several features in accordance with the present invention. Flash memory and EPROM are example devices that may be used to implement non-volatile memory 530. In general, each of these memory units represent computer readable medium from which instructions are retrieved and executed to provide several features of the present invention.

Video pre-processing block 550 receives a video signal on path 145, and performs tasks such as analog-to-digital conversion (if the video signal is received in analog form), image enhancement, color correction, image scaling, brightness and contrast correction etc., and provides a digitized signal (video data representing many pixels) to de-gamma block 560 on path 556.

Processing unit 510 may contain one or more processors and registers. Some of the processors can be general-purpose processors, which execute instructions provided from RAM 520 (via path 521) and/or non-volatile memory 530 (via path 531). Some can be special purpose processors (e.g., for video processing acceleration) adapted for specific tasks (e.g., video processing). Processing unit 510 reads sequences of instructions from various types of memory media (including RAM 520 and non-volatile memory 530) and executes the instructions to provide several features of the present invention. Processing unit 510 may also copy software instructions and data (for example, de-gamma data) from non-volatile memory 530 to RAM 520 for faster execution.

Specifically, processing unit 510 reads de-gamma data stored in a compressed form (such as described with respect to table 400 of FIG. 4) from non-volatile memory 530 or from RAM 520, and provides the de-gamma data (e.g., in the form of a table) to de-gamma block 560 via path 516. The de-gamma data generally needs to be generated consistent with the compression and storage techniques employed in generating the data stored in non-volatile memory 530. In other words, processing unit 510 may decompress the compressed de-gamma data to generate the de-gamma data provided on path 516.

De-gamma block 560 performs de-gamma correction on video data received from video pre-processing block 550 using de-gamma data received from processing unit 510. Assuming the de-gamma data is represented in the form of a table, de-gamma correction entails a table lookup for each of the points/pixels of the video data. De-gamma block 560 forwards de-gamma corrected video data to video post-processing block 570 via path 567 for further processing.

Video post-processing block 570 performs processing operations such as image formatting to render the video data suitable for display, and provides processed video data to a display device (such as display 160 of FIG. 1, but not shown in FIG. 5) on path 146. Video post-processing block 570 may also store the processed video data in RAM 520 via path 527. The image frames thus stored, are used to generate the display signals.

As noted above, de-gamma block 560 may decompress the de-gamma values received from processing unit 510. The manner in which such reconstruction can be performed is described below with an example.

### 7. RECONSTRUCTION OF DE-GAMMA VALUES

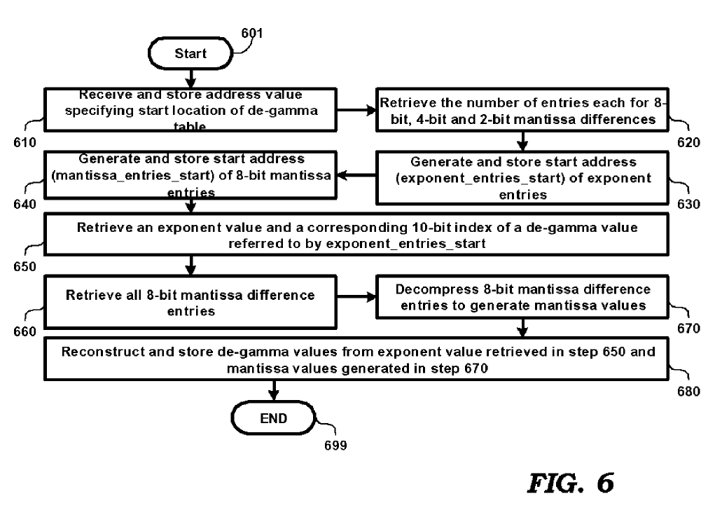

FIG. 6 is a flowchart illustrating the manner in which the values (stored in compressed form) can be reconstructed in an embodiment of the present invention. The flowchart is described with reference to FIGS. 4 and 5 merely for illustration. However, the features can be implemented in various other environments as will be apparent to one skilled in the relevant arts by reading the disclosure provided herein. Many such implementations are contemplated to be covered by various aspects of the present invention. Furthermore, though the steps are described as being performed in a particular sequence, it should be appreciated that the steps can be performed in a different sequence without departing from the scope and spirit of several aspects of the present invention. The flowchart starts in step 601, in which control passes immediately to step 610.

In step 610, processing unit 510 receives an address value (hereafter referred to as “table_start”) specifying the start location of table 400. Processing unit 510 stores the “table start” in a register (contained within processing unit 510, but not shown) or memory location for future use. From FIG. 4, it may be seen that the “table start” would refer to field 401, the start location of table 400. Control then passes to step 620.

In step 620, processing unit 510 reads (retrieves) the entry in field 401 (the number of 8-bit mantissa differences) by issuing an 8-bit memory-read instruction with address equal to “table_start”, and stores the retrieved entry for further use. Processing unit 510 similarly reads and stores entries in fields 402 and 403 (the number of 4-bit mantissa differences and the number of 2-bit mantissa differences respectively) by successively incrementing the value of (a copy of) table_start, and issuing memory read instructions. Control then passes to step 630.

In step 630, processing unit 510 generates an address “exponent_entries_start” specifying the start location (i.e., field 405) of the exponent entries in fields 405-408 by further incrementing by 1 the value the copy of “table_start” obtained at the completion of step 620. Processing unit 510 stores the address “exponent_entries_start”. Control then passes to step 640.

In step 640, processing unit 510 generates and stores an address “mantissa_entries_start” specifying the start location (i.e., field 409) of the mantissa entries (starting with the 8-bit mantissa difference entries) using the following relation:

mantissa_entries_start=table_start+2*(number of 8-bit mantissa differences+number of 4-bit mantissa differences+number of 2-bit mantissa differences)+4 Equation 1

wherein the number of 8-bit, 4-bit and 2-bit mantissa differences in the above relation were obtained in step 620, and wherein a value of 4 is added to account for the first 4 bytes used for storing the number of 8/4/2 bit differences, i.e. fields 401, 402 and 403. Control then passes to step 650.

In step 650, processing unit 510 issues a 16-bit memory-read instruction with address equal to “exponent_entries_start” to read the 5-bit exponent value contained in field 405 and also the corresponding 10_bit index in field 406 of the last de-gamma data which uses this exponent, using address “exponent_entries_start”.

As noted above, processing unit 510 may issue memory-read instructions in step 650 to read a 16-bit data in a single-read operation, as against the retrieval operations in step 620 above which retrieve 8-bit data. Processing unit 510 may achieve this by selecting appropriate addressing modes for the memory-read instructions, as is well known in the relevant arts. Control then passes to step 660.

In step 660, processing unit 510 issues an 8-bit memory-read instruction to retrieve and store the mantissa difference entry in field 409 referred to by the current value of “mantissa_entries_start” (obtained in step 640). Processing unit 510 similarly retrieves and stores the mantissa difference entries in field 410-411 by successively incrementing the value of “mantissa_entries_start” and issuing memory-read instructions for a number of iterations equal to the 10-bit index value retrieved from field 406 in step 650 above. Control then passes to step 670.

In step 670, processing unit 510 decompresses the 8-bit mantissa difference entries retrieved in step 660 using the following relation:

Mn=MOD[((Mn−1)+(Yn−1)), 128] Equation 2

wherein,

Mn is the nth (decompressed) mantissa value.

Mn−1 is the (n−1)th (decompressed) mantissa value.

Yn−1 is the (n−1)th 8-bit mantissa difference entry.

MOD represents a modulus operation, which provides the modulo-128 sum of the term

((Mn−1)+(Yn−1)).

It may be noted that the modulus operation is performed to account for the addition of a value of 128 when a mantissa difference yields a negative number, as described above in section 4. Control then passes to step 680.

In step 680, processing unit 510 reconstructs the original de-gamma values from the exponent value retrieved in step 650 and the mantissa values obtained after decompression in step 670 by concatenating, in each case, the mantissa value and the exponent value. Control then passes to step 699, where the flowchart ends.

Merely for conciseness, the flow chart of FIG. 6 illustrates the decompression of mantissa differences corresponding to one value of exponent only (viz., the decompression of the 8-bit differences (fields 409-411) with corresponding exponent value contained in field 405). However, the flowchart can be repeated for the output values stored using 4-bit and 2-bits.

Once the values are thus reconstructed, the de-gamma correction can be performed in a known way and display of the images continued.

### 8. CONCLUSION

While various embodiments of the present invention have been described above, it should be understood that they have been presented by way of example only, and not limitation. Thus, the breadth and scope of the present invention should not be limited by any of the above described embodiments, but should be defined only in accordance with the following claims and their equivalents.

What is claimed is:

1. A method of processing a monotonic curve specified by a high order equation in a digital processing system, said method comprising:
representing each of a first plurality of points of a first section of said monotonic curve using a first number of bits in a floating point representation, and each of a second plurality of points of a second section of said monotonic curve using a second number of bits also in said floating point representation,
wherein said first number of bits is not equal to said second number of bits.

2. The method of claim 1, wherein each of said first plurality of points and said second plurality of points is represented in the form of a mantissa value and an exponent value, wherein multiple points on said first section have a first value for said exponent value, and multiple points on said second section have a second value for said exponent value, wherein said method further comprises:
compressing said first plurality of points and said second plurality of points, wherein said first number of bits and said second number of bits correspond to a compressed representation of said first plurality of points and said second plurality of points respectively.

3. The method of claim 2, wherein said compressing further comprises:
determining a first difference between mantissa values of successive points located on said first section of said monotonic curve;
storing each of said first difference between mantissa values using a fourth number of bits;
determining a second difference between mantissa values of successive points located on said second section of said monotonic curve; and
storing each of said second difference between mantissa values using a fifth number of bits,
wherein said fourth number is not equal to said fifth number.

4. The method of claim 3, further comprising representing an exponent value for said first section using a sixth number of bits and an exponent value for said second section using a seventh number of bits, wherein said sixth number of bits plus said fourth number of bits equals said first number of bits, wherein said seventh number of bits plus said fifth number of bits equals said second number of bits.

5. The method of claim 4, wherein said sixth number of bits equals said seventh number of bits.

6. The method of claim 4, wherein data representing said first plurality of points and said second plurality of points is stored in a memory, said method further comprising:
reconstructing said first plurality of points and said second plurality of points from said data stored in said memory.

7. The method of claim 2, wherein said monotonic curve represents a de-gamma curve.

8. The method of claim 7, wherein said digital processing system comprises a television system.

9. A method of processing a video signal, wherein a brightness level of points of said video signal is represented according to a de-gamma curve, said method comprising:
receiving a first plurality of mantissa values for a first plurality of points on a first section of said de-gamma curve and a second plurality of mantissa values for a second plurality of points on a second section of said de-gamma curve, wherein each of said first plurality of mantissa values is represented by a first number of bits and each of said second plurality of mantissa values is represented by a second number of bits, wherein said first number of bits is not equal to said second number of bits, wherein all points on said first section have a first value for an exponent and all points on said second section have a second value for said exponent, wherein said first value is not equal to said second value;
reconstructing each of said first plurality of points and said second plurality of points from the corresponding exponent value and the corresponding mantissa value; and
correcting said brightness level of points of said video signal using the reconstructed points representing said first section and said second section of said de-gamma curve.

10. The method of claim 9, wherein a memory further stores said first plurality of mantissa values, said second plurality of mantissa values, and said exponent value for each of said first section and said second section, wherein said receiving retrieves said exponent value for each of said first section and said second section, said first plurality of mantissa values, and said second plurality of mantissa values from said memory.

11. A computer readable medium carrying one or more sequences of instructions in a system to process a monotonic curve specified by a high order equation, wherein execution of said one or more sequences of instructions by one or more processors contained in said system causes said one or more processors to perform the actions of:
representing each of a first plurality of points of a first section of said monotonic curve using a first number of bits in a floating point representation, and each of a second plurality of points of a second section of said monotonic curve using a second number of bits also in said floating point representation,
wherein said first number is not equal to said second number.

12. The computer readable medium of claim 11, wherein each of said first plurality of points and said second plurality of points is represented in the form of a mantissa value and an exponent value, wherein multiple points on said first section have a first value for said exponent value, and multiple points on said second section have a second value for said exponent value,
wherein said one or more sequences of instructions by said one or more processors comprises:
compressing said first plurality of points and said second plurality of points.

13. The computer readable medium of claim 12, wherein said compressing further comprises:
determining a first difference between mantissa values of successive points located on said first section of said monotonic curve;
storing each of said first difference of said mantissa values using a fourth number of bits;
determining a second difference between mantissa values of successive points located on said second section of said monotonic curve; and
storing each of said second difference of said mantissa values using a fifth number of bits,
wherein said fourth number is not equal to said fifth number.

14. The computer readable medium of claim 13, wherein an exponent value for said first section is represented using a sixth number of bits and an exponent value for said second section using a seventh number of bits, wherein said sixth number plus said fourth number equals said first number, wherein said seventh number plus said fifth number equals said second number.

15. The computer readable medium of claim 14, wherein said sixth number equals said seventh number.

16. The computer readable medium of claim 12, wherein data representing said first plurality of points and said second plurality of points is stored in a memory, and wherein multiple points on said first section have a first value for said exponent value, and multiple points on said second section have a second value for said exponent value, wherein said data represents said first plurality of points and said second plurality of points in a compressed form.

17. A video system comprising:
a video data processing block receiving data representing a video signal in digital form, said video signal being gamma-corrected, said video data processing block comprising:
a memory storing a de-gamma curve in a compressed floating point form, wherein each of a first plurality of points of a first section of said de-gamma curve is represented using a first number of bits in a floating point representation, and each of a second plurality of points of a second section of said de-gamma curve is represented using a second number of bits also in said floating point representation, and wherein said first number is not equal to said second number; and
a processing unit designed to process said data representing said video signal to de-gamma correct said video signal based on said de-gamma curve and generate a corrected video signal; and
a display unit displaying an image represented by said corrected video signal.

18. The video system of claim 17, wherein each of said first plurality of points and said second plurality of points is represented in the form of a mantissa value and an exponent value, wherein multiple points on said first section have a first value for said exponent value, and multiple points on said second section have a second value for said exponent value.

19. The video system of claim 18, wherein said memory stores each of a first difference between mantissa values of successive points located on said first section of said de-gamma curve using a fourth number of bits, and each of a second difference between mantissa values of successive points located on said second section of said de-gamma curve using a fifth number of bits, wherein said fourth number is not equal to said fifth number.

20. The video system of claim 19, wherein said memory also stores said first value using a sixth number of bits, and said second value using a seventh number of bits, wherein said sixth number plus said fourth number equals said first number, wherein said seventh number plus said fifth number equals said second number.
